(19) United States
(12) Patent Application Publication
(10) Pub. No.: US 2003/0163418 A1
(43) Pub. Date: Aug. 28, 2003

(54) Third party real-time multi-payment and remittance system

(76) Inventor: Audrey Marks, Kingston (JM)

Correspondence Address: Patricia E. McQueeney, Esq., Becker & Poliakoff, P.A., 3111 Stirling Road, Fort Lauderdale, FL, 33312, US

(21) Appl. No.: 10/370,547

(22) Filed: Feb. 20, 2003

(30) Foreign Application Priority Data
Feb. 27, 2002 (JM) 18/1/4162

(51) Int. Cl. G06F 17/60

(52) U.S. Cl. 705/39

(57) ABSTRACT

The “Third Party Real-Time Multi-Payment and Remittance System” is a computer-enabled system that facilitates multiple third party bill payments and remittances to multiple vendors simultaneously, with on-line and real-time updates.

Cross-Reference to Related Applications

This application claims benefit under 35 U.S.C. § 119 (e) to Jamaican Patent No. 18/1/4162, filed Feb. 27, 2002.

### BACKGROUND OF THE INVENTION

Many service companies have attempted to implement various measures to facilitate the customers' need for a fast, convenient and efficient method of paying bills and other types of payments. One such method is the use of a cashiering software or payment processing system, which serves a single client entity at a time and is either operated by the client entity or by a third-party. The transactions are normally communicated in a delayed-time environment.

The present invention is the first system and methodology to comprehensively address the customers' need for a fast, convenient and efficient method to pay multiple bills or to conduct other financial transactions through a third-party payee without any requirements from the customer. It is the first electronic multi-payment to multi-vendor system. In addition, the System constitutes a method for making and processing multiple payments to multiple vendors simultaneously and automatically in real-time.

The invention is also the first such system that is operational in both an off-line and an on-line (Internet and Intranet) environment, and this enables it to serve customers and client entities anywhere in the world.

The prior art comprises customized cashiering software systems that rely on several manual processes, such as batching, which require repeated human intervention. These prior art systems enable a customer to conduct one transaction covering a limited amount of client entities. The prior art systems and methodology are off-line, so that the customer has to physically visit or call the payee outlet. In this partly manual-based process, with batched online updates, the number of client entities that can be served is limited to a few local companies and the capability for multiple payments is restricted. The mechanism by which the prior art operates is manual and therefore the communication of the customer transaction details to the client entity is delayed as opposed to “real time.”

### BRIEF SUMMARY OF THE INVENTION

The “Third Party Real-Time Multi-Payment and Remittance System” (hereinafter called “the System”) is a computer-enabled system that facilitates multiple bill payments and money and data transfers to multiple clients simultaneously with on-line and real-time updates.

### BRIEF DESCRIPTION OF THE DRAWINGS

The System is more particularly described in the attached figures described below:

FIG. 1—System Diagram—This diagram represents the components of the multi-payment to multi-vendor cashiering application process with the three entry points, i.e., the Interactive Voice Response, the Web-based Application and the Stand Alone Computer, as well as the System's interaction with the Scheduler, the Database Management System (“DBMS”), Data Conversion Utilities (“DCU”) and Back-end business processes.

FIG. 2—Cashier Process Flow—This diagram outlines the process flow at a cashiering station. The steps within the dotted box are continued repetitively until the settlement and logout functions are performed. Each step involves real-time communication with the DBMS.

FIG. 3—Process Transaction—This diagram outlines the details involved in the “Create Transaction” process box from FIG. 2. It demonstrates the ability to handle both the payment of bills as well as the inventory items. As noted above, these steps may interact in real time with the DBMS.

FIG. 4—Cashier Settlement Process Flow—This diagram outlines the details of the “Perform Settlement” process from FIG. 2. It demonstrates the manual components of the process, and how these components interact with the invention.

FIG. 5—True Sync Process Flow—This diagram outlines the details of how the invention handles data processed when switching from off-line to on-line mode. These steps occur with no intervention from the cashier.

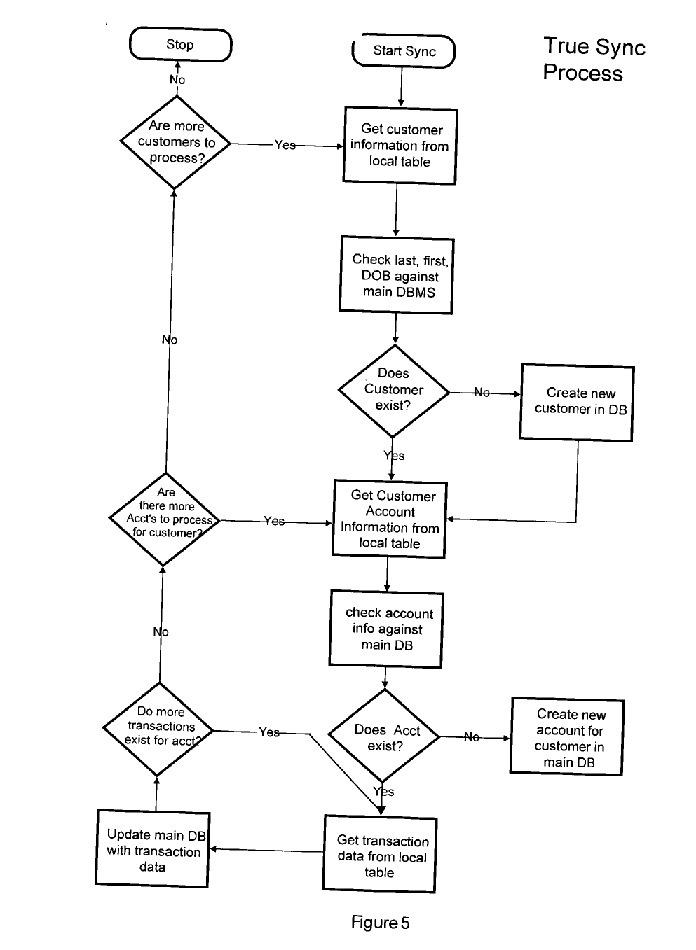

### DESCRIPTION OF THE INVENTION

Throughout the specification and claims, the term “connectivity” refers to modes of connecting to the System including cable, internet, intranet, radio or other wireless based communication devices, utilities and applications.

Throughout the specification and claims, the term “telephone” refers to both regular and wireless telephone systems.

Throughout the specification and claims, the term “financial transactions” refers to money and data transfers, remittances, purchase money orders, bill settlements, inventory purchases.

Throughout the specification and claims, the term “payer” refers to any customer who utilizes the System to pay bills, purchase inventories or forward money orders to a client entity.

Throughout the specification and claims, the term “payee” or “third party payee” refers to the operator of the present System.

Throughout the specification and claims, the term “client entity” refers to any customer who utilizes the system to obtain payment from a payer for outstanding invoices, inventory and/or money.

Throughout the specification and claims, the term “legal tender” refers to any legal tender now in existence or developed in the future, including, but not limited to, cash, check, credit card, and debit card.

Throughout the specification and claims, the term “real time” refers to instantaneous data transmittal.

The System enables a payer to pay multiple bills, purchase inventories and pay money transfers/remittances via a single or multiple payments to one or multiple client entities via the telephone, wireless communication device, the Internet, or by visiting an outlet of the payee.

In the case where the payer visits the payee outlet, a cashier collects from the payer a single payment and/or multiple payments for different types of bills or payments, destined to different service companies and entities, including utilities, telecommunications, banks, insurance companies (hereinafter called “client entity”). In the case where the payer contacts the payee via telephone, the payee through integrated voice response system [known art] records the transaction details. In the case where the payer contacts the payee via the payee website over the Internet, the payer inputs the transaction details directly on the computer.

Once the transaction details are given, whether by the payer over the Internet or to the cashier in the payee outlet, the System is configured to enable the payee to enter details of the multiple-payment to multiple-client entity electronically via a single screen. Once these details are entered, the software component of the System, through computer readable instructions and without the intervention of the cashier, connects to the central DBMS and places the transaction data in the central DBMS.

On finding data in the DBMS, the System enables the Data Conversion Utility (DCU) to reformat and aggregate each client entity's data and through the Scheduler transmit it electronically to a specified client entity's electronic storage locations. The Scheduler application then, through computer readable instructions, collects all the transactions for each client entity from the DBMS and transmits this transaction data to the client entity drop off point over the Internet. The Scheduler can be set to activate real-time or time-delayed for a client entity on a per client entity basis.

The System can operate either in on-line or off-line modes transparent to the cashier. In the on-line mode, it synchronizes in real-time the customer information and transactions with the central DBMS and electronically transmits this information to the client entity's drop off point. In the off-line mode, it collects new customer information and transactions. The System perceives when it goes off-line and on-line and automatically switches into the appropriate mode. The System therefore does not require the intervention of the cashier in the eventuality of a communication disruption or other event that interrupts online connections.

The invention is a computer-enabled system, which comprises a multi-payment to multi-vendor cashiering application process that exists as a web-based application, a stand-alone application and an interactive voice response application. The invention enables a payer to carry out multiple financial transactions via a single or multiple payments through the payee through various modes of connectivity or by visiting an outlet of the payee.

The System interacts with a centralized Database Management Store (DBMS). The System also interacts with a Scheduler (software that polls/checks a database on a scheduled basis), which can be set to activate in real-time or time-delayed. The invention is designed to work in a web-enabled environment, through various modes of connectivity as well as off-line. The System interacts with other elements, such as data conversion utilities and back-end business processes.

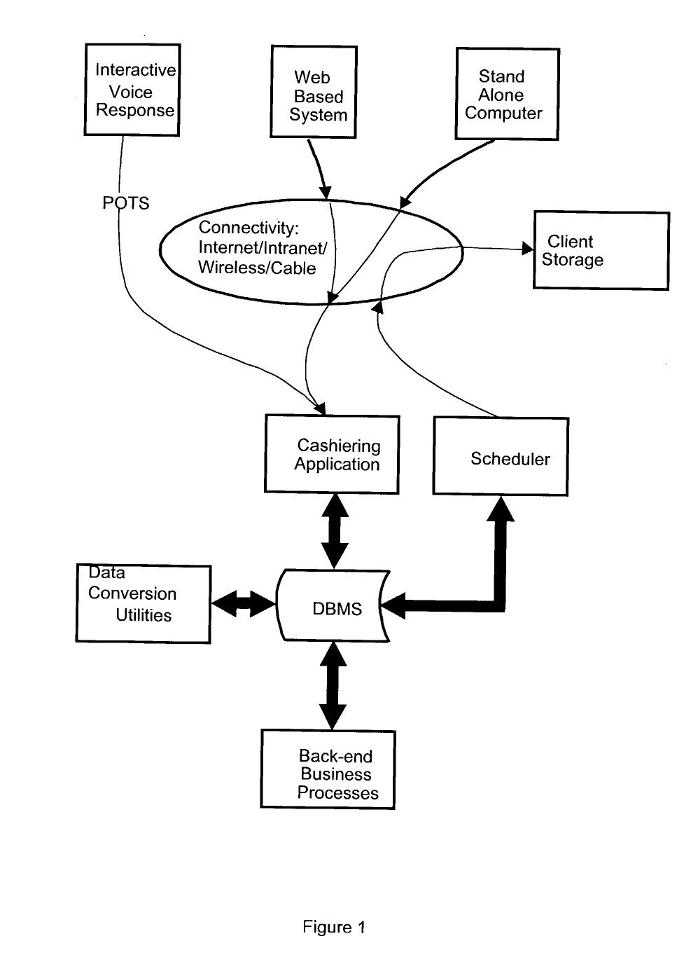

FIG. 1 provides schematic details of one embodiment of the System. In this embodiment, the System is comprised of a Database Management System (“DBMS”), being any software which works with a processor/server to receive, store and process data. The DBMS is the central hub of the System.

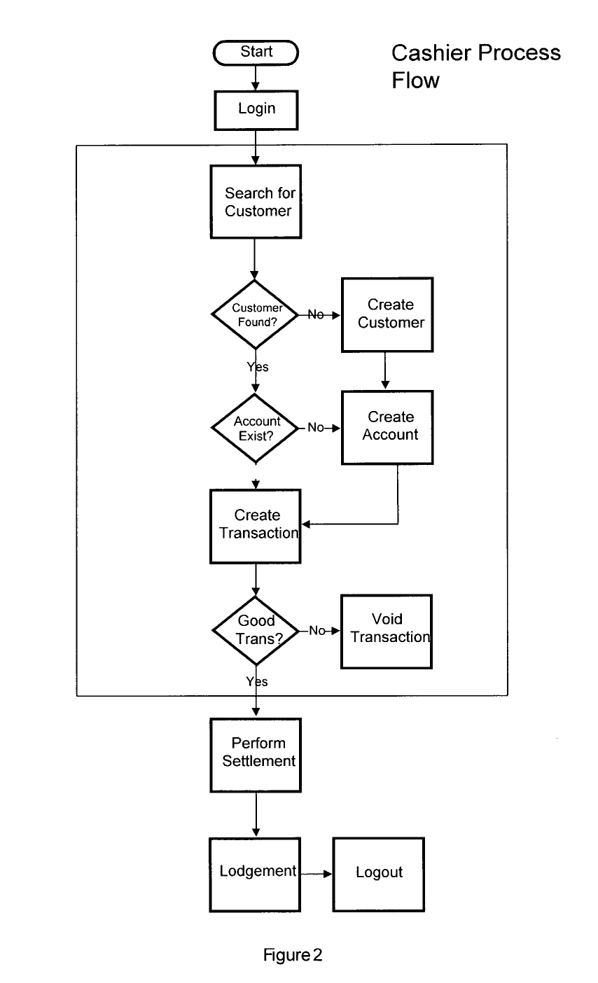

The DBMS interacts with the Cashiering Application in on-line mode. The Cashiering Application is software that assists the payee in entering the required information that allows the System to operate properly. As depicted in FIG. 1, a payer can access the Cashiering Application software via interactive voice response through a telephone, via a stand-alone computer, via a web-based computer application or via interaction with a human cashier who requests information from the payer and enters it into the computer software. The Cashiering Application software can be utilized in on-line or off-line mode. Further detail of the Cashiering Application software is provided in the detailed description of FIG. 2.

Remaining in FIG. 1, the DBMS also interacts with the Data Conversion Utilities (DCU). The DCU is a software program designed to interact with the DBMS to convert data stored therein to a previously defined file format acceptable to the client entity.

As shown in FIG. 1, the DBMS also interacts with the Back-End Business Processes. The Back-End Business Processes is a software program that receives data from the DBMS, which received data from the Cashiering Application, and organizes this information by client entity. The Back-End Business Processes software automatically provides the necessary accounting, auditing and inventory functions required by each client entity and for all necessary third-party payee's back office operations.

Finally, again in FIG. 1, the DBMS also interacts with the Scheduler. The Scheduler is additional software that checks the DBMS on a scheduled basis. The Scheduler software collects the data entered into the System and stored in the DBMS and transmits this information to each client entity. As shown in FIG. 1, the Scheduler software connects with the client entity via internet dial up to communicate real-time or batched updates to payer accounts with the client entities.

FIG. 2 provides schematic details of the Cashiering Application of FIG. 1. When a payer wishes to pay multiple bills simultaneously, the payer can either telephone, log on to their computer or walk to a facility that has a cashiering station. Using any of these methods, the payer will be prompted to enter information pertaining to their account. When using the telephone, the payer may be connected to a live person or to an interactive voice response system. When using their personal computer and the internet, the payer will be prompted through fill-in-the-blank forms. When using a facility with a cashiering station, the payer may interact with a live person who will enter the pertinent information into a computer or the customer payer may be directed to a stand-alone computer where they will be prompted through fill-in-the-blank forms similar to the payer using their personal computer.

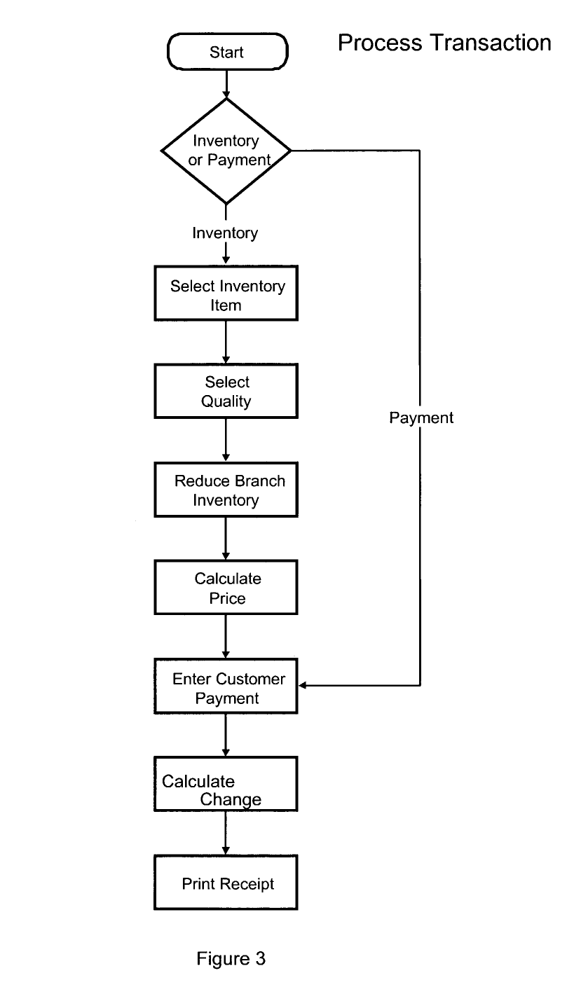

As evidenced by the flow chart, a payer does not have to have an account with the third party payee in order to utilize the System. After entering their information, the Cashiering Application software automatically creates an account for the payer if a prior transaction has not been processed for that payer. As the Cashiering Application software is creating the account, the payer is not inconvenienced by the time delays inherent in opening accounts with other institutions, such as banks and credit card companies. If a prior transaction is found for that payer or, after automatically establishing an account for a new payer, the Cashiering Application software automatically moves on to the Create Transaction dialog. More information on the Create Transaction process is provided in the Detailed Description of FIG. 3.

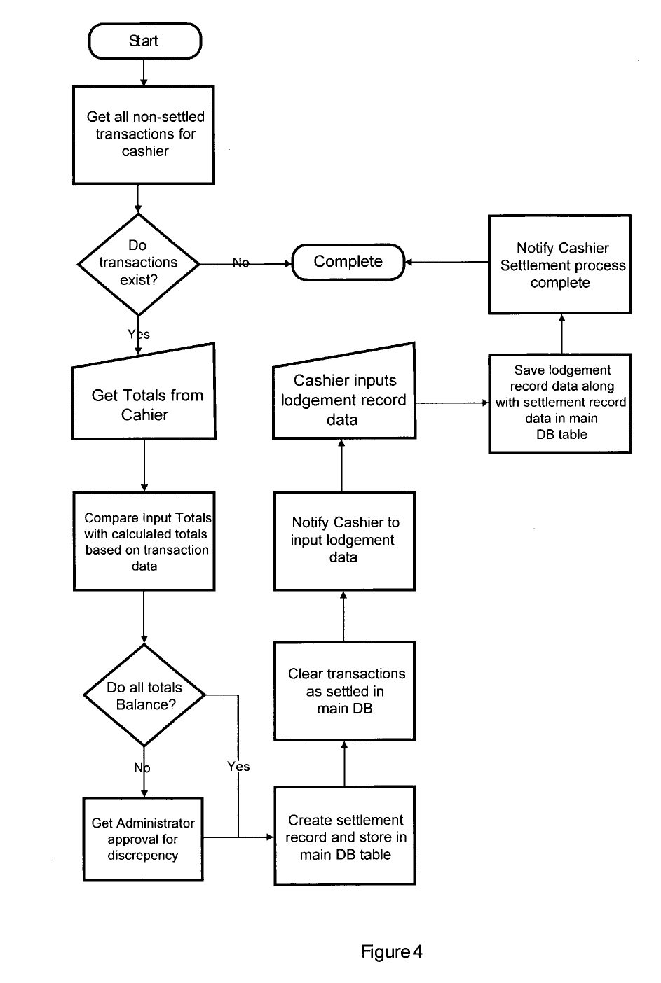

After successfully completing the Create Transaction process, the Cashiering Application software evaluates whether the transaction was a good transaction or not. This evaluation is based on visual verification by the cashier of the correctness of the displayed transaction information, which remains voidable and if an error is observed it allows the cashier to correct before finalizing the transaction data. If the transaction is carried out via telephone or the internet the payer himself/herself is prompted to verify the entered transaction data through respectively audio or visual verification procedure and allowed to make whatever corrections desired before completing the transaction record. Once the transaction passes the verification the transaction record is complete and the Cashiering Application software inquires if there is another transaction to be performed. If so, the Cashiering Application software returns to the Create Transaction step of the process. If not, the Cashiering Application software moves on to Perform Settlement and Lodgment. The Detailed Description of FIG. 4 provides schematic details of the Perform Settlement and Lodgment steps of FIG. 2.

FIG. 3 provides schematic details of the Create Transaction step of FIG. 2. The Cashiering Application software first determines what type of financial transaction, ie. whether the payer is purchasing inventory or paying a bill etc. If the payer is purchasing inventory, the Cashiering Application software selects the inventory item and quantity based on the payer input information, reduces the total inventory of the client entity by the same quantity, and determines the price due for the quantity of inventory selected by the Payer. The Cashiering Application software then enters the amount of the Customer Payment. If the payer is paying a bill, the amount of the Customer Payment would be the first step to which the Cashiering Application software would go. The Cashiering Application software determines the amount of change due to the Payer and prints or e-mails a receipt.

A payer can use cash, check, debit, credit or value card to conduct all desired financial transactions. The payer can determine the quantity of money needed for the monthly bills and provide that amount of tender at a cashiering station to either the real person or to the stand-alone computer. The System relieves the payer of having to visit each establishment with which they have a bill, which could result in additional traveling expenses. The System also eliminates the requirement of the payer to obtain cashier's checks or money orders and stamps to mail bill payments. The payer can also pay one large sum of money via cash, check or charge to enable them to conduct financial transactions until that sum of money is depleted. The payer can then replenish their account with cash, check or charge as needed. If the payer is neither a fixed-income customer nor a large business venture customer, but a payer who has misplaced a bill until the last minute, or who wishes to ease the monthly bill paying process, this payer can utilize cash, check or charge to pay any bill or purchase any inventory they wish.

FIG. 4 provides schematic details of the Perform Settlement step of FIG. 2. The Cashiering Application software is part of every cashier's log-off procedure. All transactions executed by each cashier for the day/shift are totaled and the total transactions record is displayed on the monitor. Each cashier physically counts the funds on hand (either cash or checks) and inputs the relevant totals, which the Cashiering Application then automatically compares against the record to verify that all totals balance. If there is a discrepancy between actual funds on hand and the total transaction record, the Cashiering Application software notifies a System Administrator (a person so designated by the payee), who then must approve the discrepancy by referring/reporting same to Audit department for reconciliation before the log-off process may proceed. After approval from the System Administrator, or if the cashier's funds on hand match the total transactions record, the Cashiering Approval software creates a settlement record, which is sent to the central DBMS for storage. The Cashiering Approval software than clears the cashier as settled.

After clearing the transactions as settled, the Cashiering Approval software moves on to the Lodgment step of the Cashiering Application of FIG. 2. The terms “lodgment” and “deposit” are synonyms. The data for total funds on hand is entered into the Cashiering Application software for the purpose of creating a lodgment record. The Cashiering Application software automatically forwards this information to the central DMBS for storage with the settlement record. The Cashiering Application software proceeds to notify the Cashier that the settlement and lodgment processes are complete.

### UTILITY OF THE INVENTION

The Third Party Real-Time Multi-Payment and Remittance System provides a fast, efficient and convenient method for the payment of bills and the collection and paying out of remittances. In an age where heavy traffic and busy work schedules prevent many people from paying their various bills on time, the System is an ideal solution for payers as well as client entities.

A payer can either physically visit the payee's outlet, telephone the payee or go to the payee's website, conduct one transaction in settlement of a telephone bill, an electricity bill and water bill as well as an invoice for a product. The System will electronically and simultaneously sort, process and transmit the payment details to each client entity in real time (automatically) or batched as desired by each client. The payer therefore has the convenience of making multi-payments by one transaction with the payee. The System thereby saves the payer time and transportation costs by facilitating a one-stop shop for money transfers and all his/her other transactional needs.

The System electronically carries out processes which a cashier at the front end and an accounts clerk at the back end would, without the System, have to carry out manually. Hence, the System provides a time efficient method for the payment of bills and remittances. This affords the payer the opportunity to make last minute payments and quick money transfers from all over the world, which will still reach the client entities on time, without having to go to individual client entities or to the bank.

The invention affords each client entity the option to outsource collections and payments to a payee. Each client entity therefore gains the benefits of assistance with receivables, thereby allowing for better concentration on its core business, while outsourcing such services at zero capital outlay on its part. It also affords the client entity the facility of real-time updates done electronically, which is not available through client entity outlets or banks. Because of the System's interface with the back-end business processes, it is also able to provide client entities with management and audit reports, as well as reconciliation in electronic and hard copy format.

The System extends to banking and other transactions such as the payment of government taxes and the purchase of physical goods, as the System's capacity to serve client entities is unlimited. The System is also able to serve local and overseas client entities because of its on-line web-based application and its use of Internet technologies for communication. This facilitates the payment of bills and the sending of money transfers to and from anywhere in the world.

We claim:

1. A system by which one or more payers can pay one single transaction to one payee, who disburses said one single transaction to one or more client entities in real time, said system comprising:
A. a cashiering application;
B. a database management system;
C. a data conversion utility;
D. a scheduling utility; and
E. a back-end business process system.

2. The system of claim 1 wherein said one or more payers can pay multiple bills to more than one of said one or more client entities via said one single transaction to said one payee.

3. The system of claim 1 wherein said one or more payers can purchase inventory from said one or more client entities via said payee.

4. The system of claim 1 wherein said one or more payers can pay one single transaction with any legal tender.

5. The system of claim 1 wherein said cashiering application comprises an interactive voice response system activated by the payer via telephone.

6. The system of claim 1 wherein said cashiering application comprises a human cashier at a payee outlet.

7. The system of claim 1 wherein said cashiering application comprises software available to the payer via the internet.

8. The system of claim 1 wherein information obtained by said cashiering application is transmitted to and stored on said database management system in real time.

9. The system of claim 1 wherein information obtained by said cashiering application is batched, transmitted to and stored on said database management system on a time delayed basis.

10. The system of claim 1 wherein said data conversion utility comprises software utilized to organize and reformat said information stored on said database management system based on criteria and in a format provided by said client entity.

11. The system of claim 1 wherein said scheduling utility comprises software that communicates with the client entity in real time.

12. The system of claim 1 wherein said back-end business process system comprises software that automatically provides accounting, auditing and inventory functions based on criteria provided by said client entity.

13. A method for one payee to process one single transaction from one or more payors to said one payee and disburse said one single transaction to one or more client entities, said method comprising:
A. obtaining information from said one or more payors;
B. transmitting said information to a data conversion utility;
C. converting said information to the format provided by said client entity; and
D. transmitting said formatted information to said one or more client entities based on criteria provided by said one or more client entities.

14. The method of claim 13 wherein said information provided from said one or more payors comprises legal tender.

15. The method of claim 13 wherein said method transpires in real time.

16. The method of claim 13 wherein said information is obtained from said one or more payors via an interactive voice response system activated by the payer via telephone.

17. The method of claim 13 wherein said information is obtained from said one or more payers via a human cashier at a payee outlet.

18. The method of claim 13 wherein said information is obtained from said one or more payors via software available to said one or more payers via the internet or the outlet of said payee.

19. The method of claim 13 further comprising:
E. transmitting said formatted information to a back end business process system; and
F. providing accounting, auditing and inventory functions to said formatted information based on criteria provided by said client entity.

20. The method of claim 19 wherein said back end business processes comprise accounting, auditing, inventory and mixtures thereof.

21. A method of processing one single transaction from one or more payors to one payee and disbursing said one single transaction to one or more client entities, said method comprising:
A. obtaining information from said one or more payors via a cashiering application;
B. transmitting said information from said cashiering application to a database management system;
C. transmitting said information from said database management system to a data conversion utility;
D. converting said information to the format provided by said client entity;
E. transmitting formatted information to said database management system;
F. transmitting said formatted information to both the back end business processes and the scheduling utility;
G. providing accounting, auditing and inventory functions to said formatted information at said back end business processes based on criteria provided by said client entity; and
H. transmitting said formatted information from said database management system through said scheduling utility to said client entity based on criteria provided by said client entity.

22. The method of claim 21 wherein said information provided from said one or more payors comprises legal tender.

23. The method of claim 21 wherein said method transpires in real time.

24. The method of claim 21 wherein said cashiering application comprises an interactive voice response system activated by the payer via telephone.

25. The method of claim 21 wherein said cashiering application comprises a human cashier at a payee outlet.

26. The method of claim 21 wherein said cashiering application comprises software available to said one or more payers via the internet.

27. The method of claim 21 wherein said back end business processes comprise accounting, auditing, inventory and mixtures thereof.
